(19) United States
(12) Patent Application Publication
(10) Pub. No.: US 2021/0324657 A1
(43) Pub. Date: Oct. 21, 2021

(54) PORTABLE ACOUSTIC RECORDING BOOTH

(71) Applicant: IYUNO MEDIA GROUP, Burbank, CA (US)

(72) Inventors: Jinil KO, Goyang-si (KR); Dong Jung CHUNG, Gimpo-si (KR)

(73) Assignee: IYUNO MEDIA GROUP, Burbank, CA (US)

(21) Appl. No.: 17/235,187

(22) Filed: Apr. 20, 2021

Related U.S. Application Data
(60) Provisional application No. 63/013,459, filed on Apr. 21, 2020.
(60) Provisional application No. 63/077,970, filed on Sep. 14, 2020.

(51) Int. Cl. E04H 15/48; E04H 15/00; G10K 11/162; G06F 3/16; G06F 16/64; G10L 19/018

(52) U.S. Cl. CPC E04H 15/48; E04H 15/008; G10L 19/018; G06F 3/162; G06F 16/64; G10K 11/162

(57) ABSTRACT

A field deployable soundproof booth for remote audio dubbing including a collapsible support structure onto which a plurality of soundproof material sections are attached after the support structure has been assembled into a deployed position; and an audio dubbing system for recording and managing audio files, including: a video display system, an audio recording system, an audio and video file management system, and a communication system for transmitting audio and video files over the internet. The soundproofing material that is attached to the deployed support structure may preferably be a plurality of triangular acoustic foam sections that are attached to the support structure by hook and loop fasteners prior to use.

### RELATED APPLICATIONS

The present application claims priority to U.S. Provisional patent application Ser. No. 63/013,459, entitled Portable Acoustic Recording Booth, filed Apr. 21, 2020 and to U.S. Provisional patent application Ser. No. 63/077,970, also entitled Portable Acoustic Recording Booth, filed Sep. 14, 2020, the entire disclosures of which are incorporated herein by reference in their entireties.

### TECHNICAL FIELD

The present invention is related to soundproof enclosures and to audio dubbing systems.

### BACKGROUND OF THE INVENTION

The global entertainment experience relies on dubbing as a standard way of presenting video content internationally. Audiences now expect access to their favorite film and TV series wherever and whenever they are around the world. As a result, securing voice talent dubbers worldwide has become a global pursuit.

Recording studios traditionally require elaborate and expensive facilities that house complex audio and video equipment. The heart of a traditional recording studio is its one or many soundproof audio booths. Also required, however, is all the associated equipment for running the audio and visual equipment found in these soundproof booths. As entertainment becomes more and more global, voice talent professionals must be hired in more and more countries and in more new regional markets and territories. It can be difficult for voice talent professionals to travel to recording studios (which may or may not be available in all desired global locations). Transporting voice talent professionals to and from various recording studios around the world has been a huge logistical and expense problem even before the advent of Covid. In the past year, however, the damage that Covid has done across the world has been significant. Covid has now made travel very difficult or impossible for millions of people around the world. As such, Covid has shuttered recording studios at the very time when demand for new film and television has never been greater (with millions of people trapped at home unable to work, or working remotely).

What is therefore desired is a system that permits voice talent individuals around the world to once again return to the recording studio such that new movies and TV shows can be dubbed at locations around the world. It is also desirable to increase the access to dubbing professionals in regional markets which had been poorly served (or not served at all), by access to professional recording studios. As will be fully explained herein, the present system addresses these problems and advantageously provide novel solutions to these problems.

### SUMMARY OF THE INVENTION

In general terms, the present system provides a field deployable soundproof booth for remote audio dubbing. In preferred aspects, a plurality of soundproof material sections are attached to a support structure frame after the support structure has been assembled into a deployed position. An audio dubbing system for recording and managing audio files is then quickly set up within the deployed structure, and the system is ready for operation. The present system also preferably includes a video display system, an audio recording system, an audio and video file management system, and a communication system for transmitting audio and video files over the internet. The soundproofing material that is attached to the deployed support structure may optionally be a plurality of triangular acoustic foam sections that are attached to the support structure by hook and loop fasteners prior to use.

In one preferred aspect, the present system comprises: a soundproof audio dubbing structure with integrated sound management system, comprising: a soundproof booth, comprising: a collapsible support structure, and a plurality of soundproof material sections, wherein the plurality of soundproof material sections are configured to be attached onto the collapsible support structure after the support structure has been assembled into a deployed position; and an audio dubbing system for recording and managing audio files, the dubbing system comprising: a video display system, an audio recording system, an audio and video file management system, and a communication system for transmitting audio and video files over the internet.

Preferably, the collapsible support structure comprises a support frame and a fabric disposed around the support frame. A plurality of soundproof material sections which are preferably made of an acoustic foam are secured to the fabric or to the support frame by Velcro®-style hook and loop fasteners. In preferred embodiments, the plurality of soundproof material sections are triangular and are positioned together to form rectangles. These material sections can quickly and easily be attached through the use of hook and loop fasteners. The voice talent professional simply stands in the soundproof booth (s)he has assembled with the video display system simultaneously displaying a video and a script for dubbing.

The soundproof booth and the audio dubbing system are preferably packaged and shipped separately to the voice talent professional. Also included with the shipment are a microphone stand and a stand for an iPad stand. These stands (which may be combined into one stand) are positioned within the deployed soundproof booth after the booth frame has been set up and the acoustic material sections attached thereto. Preferably, the audio and video file management system is a software system that is resident in a software Application that is downloaded onto the iPad, computer or smart device. During operation, the audio and video file management system and the communication system are configured for real-time communication between a plurality of users each operating within one of a plurality of the soundproof audio dubbing structures with integrated sound management system. As a result, dubbing sessions can be coordinated between a studio director, a sound engineer and the voice talent professional(s) (all of which will be in different physical locations). In addition, the operation of the present audio dubbing system for recording and managing audio files can be controlled remotely.

In another preferred aspect, the present system comprises a preferred method of audio dubbing, comprising: assembling a soundproof booth by: deploying a collapsible support structure into a deployed position, attaching soundproofing material to the deployed support structure, positioning an audio dubbing system for recording and managing audio files within the assembled soundproof booth, displaying videos to a person in the soundproof booth, recording audio clips from the person in the soundproof booth, and transmitting the recorded audio clips to a remote computer system.

Advantages of the present system include at least the following:

First, it conveniently brings the recording booth to the voice talent professional. (Traditionally, the voice talent professional had to be brought into a recording booth). As a result, the present system can be seamlessly operated during Covid travel restrictions, or any other form of travel restrictions however caused. As a result, the present system and approach saves considerable time and money.

Second, the present system saves considerable space as it provides a studio-quality recording environment in a small package that can be disassembled and stored in a package about the size of a standard camping tent. Due to its extremely small size, the present system can be shipped by courier or post to remote locations around the world.

Third, once received by mail or courier by the voice talent professional, the present system can be assembled for operation in a very short time. It is easy and safe to assemble, and requires no specialized hardware to set up to or operate. One person can perform the full set up and installation themselves, typically within 30 minutes. The soundproofing material used in assembling the present system is safe and easy to handle.

Fourth, a number of different dubbing individuals can each set up their own portable recording booths and can collaborate with one another in real time. Moreover, using the present software and internet communication systems, the present system permits real-time communication control between voice talent professionals, sound engineers and program directors. Additionally, the sound engineer(s) can preferably remotely control or adjust the sound recording parameters in real time (such that the dubbing professional need not spend their time and energy making these adjustments).

### BRIEF DESCRIPTION OF THE DRAWINGS

FIG. 1A is a perspective view of the assembled system.

FIG. 1B is a cut-away perspective view of the assembled system showing the positions of the microphone stand, and an iPad stand with an iPad positioned thereon.

FIG. 2 is an illustration of the various physical components of the present system that can be shipped together to the dubbing professional.

FIGS. 3A to 3H illustrate successive steps in the setup of the present soundproof acoustic booth.

FIG. 4A is a screenshot of the sound engineer's screen prior to starting a recording session.

FIG. 4B is a screenshot of the sound engineer's screen after a sound clip has been recorded. The voice talent dubber will see a similar screen during the recording process.

FIG. 4 C is a screenshot of the sound engineer's screen after a recording has been made, showing the various participants involved, and the dialog that the voice talent dubber has been reading during the recording.

FIG. 5A is a side elevation view of an alternate (i.e.: pentagon shaped) embodiment of the present soundproof booth.

FIG. 5B is a perspective view of the soundproof booth of FIG. 5A, with one side removed, showing interior details.

FIG. 5C is a side-elevation view corresponding to FIG. 5B.

### DETAILED DESCRIPTION OF THE DRAWINGS

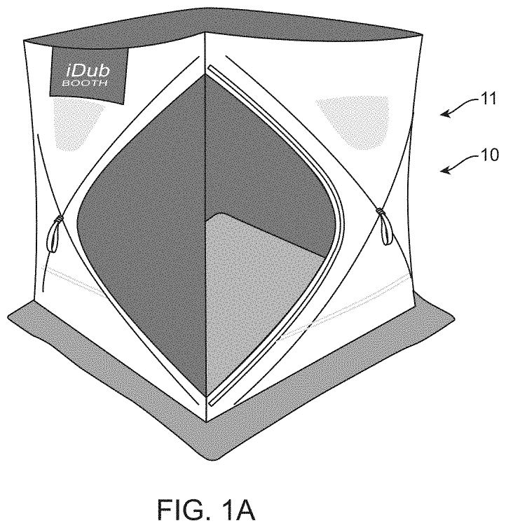

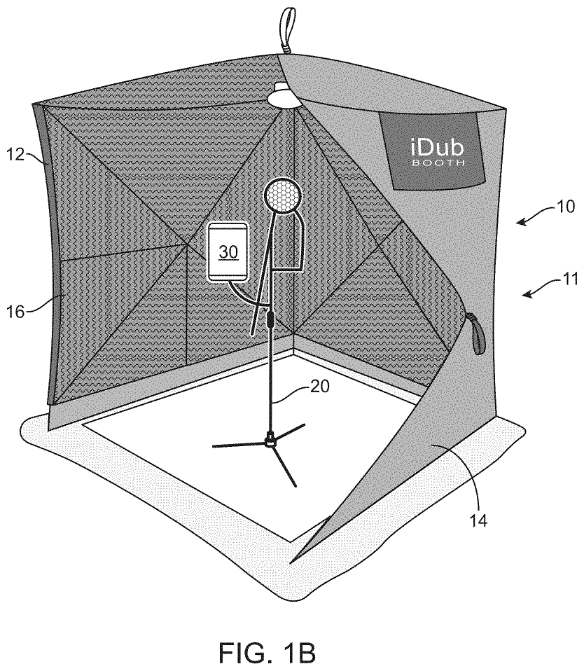

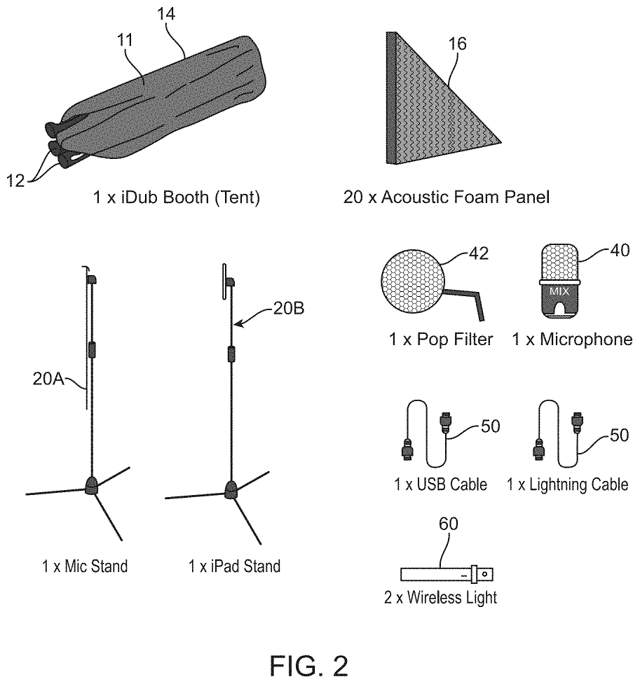

The present system provides a soundproof audio dubbing structure with integrated sound management system. FIG. 1A is a perspective view of the assembled system 10. FIG. 1B is a cut-away perspective view of the assembled system showing the positions of a combined microphone and iPad stand 20 with an iPad 30 and microphone 40 mounted thereon. System 10 comprises a soundproof booth 11 that is collapsible for easy shipping and storage. In preferred embodiments, system 10 comprises a collapsible frame 12 (similar to the pole structure of a rapid assembly camping tent frame), a fabric 14 attached to frame 12 (fabric 14 being similar to the walls of a camping tent), and a plurality of soundproof material sections 16 (FIG. 2), the novelty of which will be further explained herein. The plurality of soundproof material sections 16 are configured to be attached onto the collapsible support structure/frame 12 after the support structure/frame has been assembled into a deployed position. Preferably, soundproof material sections 16 are made of an acoustic foam.

FIG. 2 shows the various physical components of the present system that are preferably shipped together in a package to the voice talent dubber. Specifically, these shipped components are a collapsible frame 12, a microphone stand 20A and an iPad stand 20B (note: these two stands can instead be combined into one as seen in stand 20 in FIG. 1B). Microphone 40 can be accompanied by a pop filter 42. Various USB and Lightning® cables 50 can also be included as can a wireless light 60.

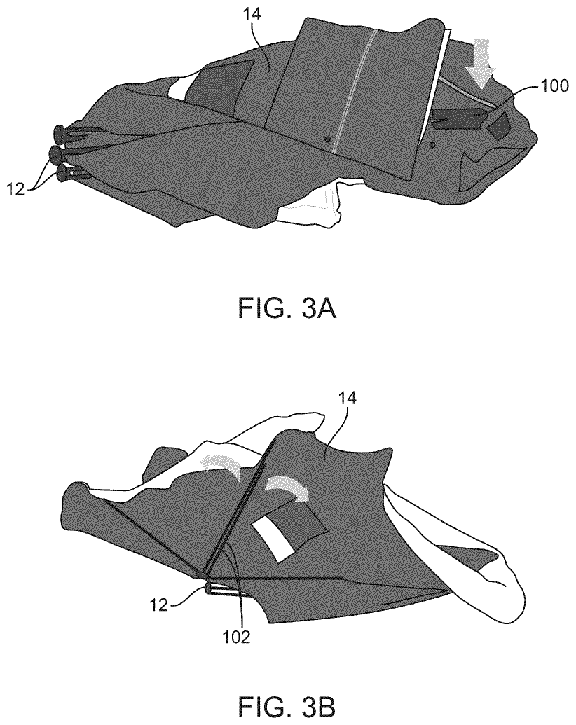

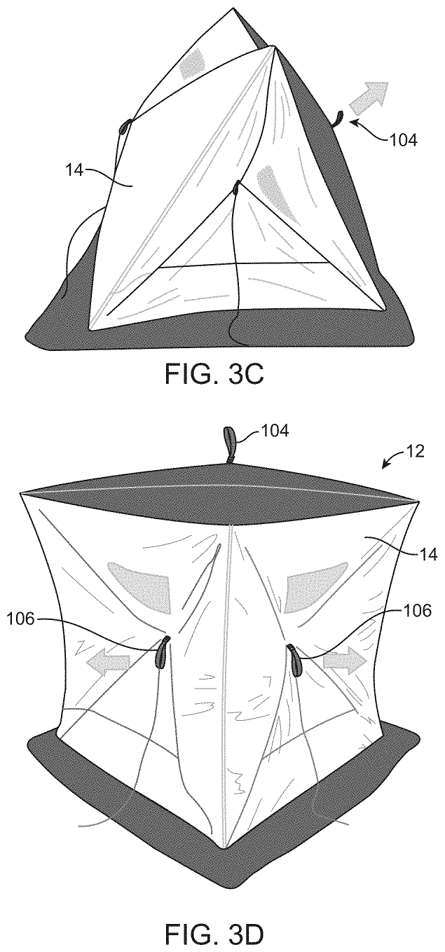

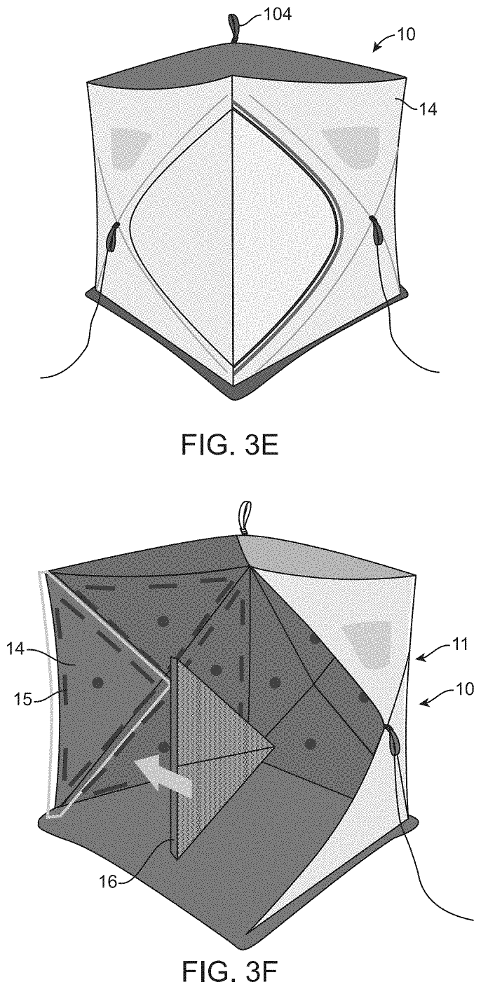

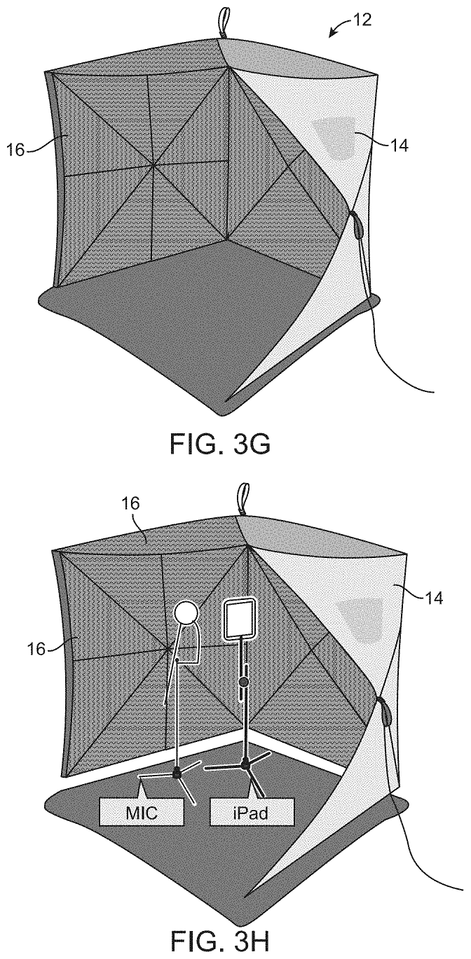

FIGS. 3A to 3H show a preferred method of setting up the present system. FIG. 3A illustrates the collapsed structure when the voice talent professional first removes it from the shipping bag. The assembler pulls on handle 100 to start the deployment process. Next, in FIG. 3B, the assembler unfolds overlapping supports 102 such that the supports 102 are visible. Next, in FIG. 3C, the assembler pulls on handle 104 to straighten out the roof of the structure. Next, as seen in FIG. 3D, the roof has been straightened out and the assembler next pulls on side handles 106, such that the structures “pops out” into the field-deployed rectangular form as seen in FIG. 3E.

A number of soundproof material sections 16 are included in the packaged shipped to the voice talent dubber. In the exemplary embodiment of the present system, twenty soundproof material sections 16 are included. As can be seen, soundproof material sections 16 can all have the same shape such that they are easily interchangeable during assembly. These soundproof material sections 16 can all be triangular in shape, but it is to be understood that the present system encompasses versions of the system with differently shaped soundproof material sections 16.

FIGS. 3F and 3G illustrate the novel approach of making the booth soundproof quickly and easily. Specifically, once the frame 12 and fabric 14 have been assembled (i.e.: unfolded and popped into the position shown in FIG. 3E), then the assembler simply takes the soundproof material sections 16 and attaches them to the inside walls and ceiling of the booth. As can be seen, eight triangular soundproof material sections 16 can be positioned together to form the square shape of one of the walls (or ceiling) of the booth. Fabric 14 preferably has Velcro® style hook and loop fasteners at various locations 15 on its inner surfaces, and soundproof material sections 16 also have Velcro® style hook and loop fasteners on one side. As can be seen, the assembler simply fits the triangular shaped soundproof material sections 16 against the four inner sides and the ceiling of the booth, thereby making the booth soundproof or substantially soundproof. As illustrated, the collapsible support structure 11 may be rectangular and the plurality of soundproof material sections 16 may be triangular, but are positioned together to cover the rectangular sides and ceiling of the booth. The advantage of this particular geometric approach (i.e.: triangles forming rectangles) is that it provides the ideal balance among the following factors: (a) all of the pieces are of identical sizes and shape and the installer is not left searching for the correct piece, (b) the individual pieces are large enough such that a small number (i.e.: only 20) of pieces are required, (c) each of the pieces are small enough that they can be easily handled by the installer, and fit together into the bag in which the collapsed frame 11 is shipped. Adopting a right angled triangle shape for the soundproof material sections 16 is ideal when the booth is cubical, as shown (since this permits the triangular shaped sections 16 to be interchangeable with one another regardless of whether they're used on the walls or the ceiling of the booth).

After installation of the soundproof material sections 16, the soundproof booth 11 is then ready to use. However, it is recommended that the user place a carpet on the floor of the booth for further soundproofing. Finally, as seen in FIG. 3H, the assembler places the microphone 40 and iPhone 30 into the booth. In preferred aspects, the present audio dubbing system for recording and managing audio files is resident in an App downloaded onto iPad 30 (or some similar computer or smart device in the booth). In preferred aspects, the present system for recording and managing audio files comprises: a video display system, an audio recording system, an audio and video file management system, and a communication system for transmitting audio and video files over the internet. The advantage of this approach is that the soundproof booth and the audio dubbing system (resident on iPad 30) are packaged and shipped separately to the user.

In preferred aspects, the present system includes a method of audio dubbing, comprising: assembling a soundproof booth by: deploying a collapsible support structure into a deployed position, attaching soundproofing material to the deployed support structure, positioning an audio dubbing system for recording and managing audio files within the assembled soundproof booth, displaying videos to a person in the soundproof booth, recording audio clips from the person in the soundproof booth, and transmitting the recorded audio clips to a remote computer system.

A dubbing session can preferably be controlled by the recording engineer with a plurality of participant dubbing professionals each being at home in their own field-deployed recording booths. These dubbing professionals can view videos, listen to recordings and collaborate and talk through the App. During operation, the audio and video file management system and the communication system are configured for real-time communication between a plurality of users each operating within one of a plurality of the soundproof audio dubbing structures with integrated sound management system. In addition, directors, assistants, dubbing supervisors and other collaborators can monitor dubbing sessions while providing feedback in real-time (just as they would in a traditional live-studio environment). Preferably, when a recording is made with the present system, the audio and video file management system watermarks recorded audio files with participant IDs.

In preferred aspects, the production system can be cloud-based, enabling real-time project management, with a global back office. The Application resident in iPad 30 is preferably configured to interface with the back-end of the cloud-based system. When controlled remotely by the sound engineer, the operation of the audio dubbing system for recording and managing audio files is controlled remotely. In this circumstance, the dubbing professionals are not required to configure the recording levels or adjust any technical settings. As such, the voice talent dubbing professional can rehearse and deliver performances while the engineer focuses on the technical aspects of the recording. The booth and mic kit provide consistency across all recordings, and allows for seamless audio matching post production.

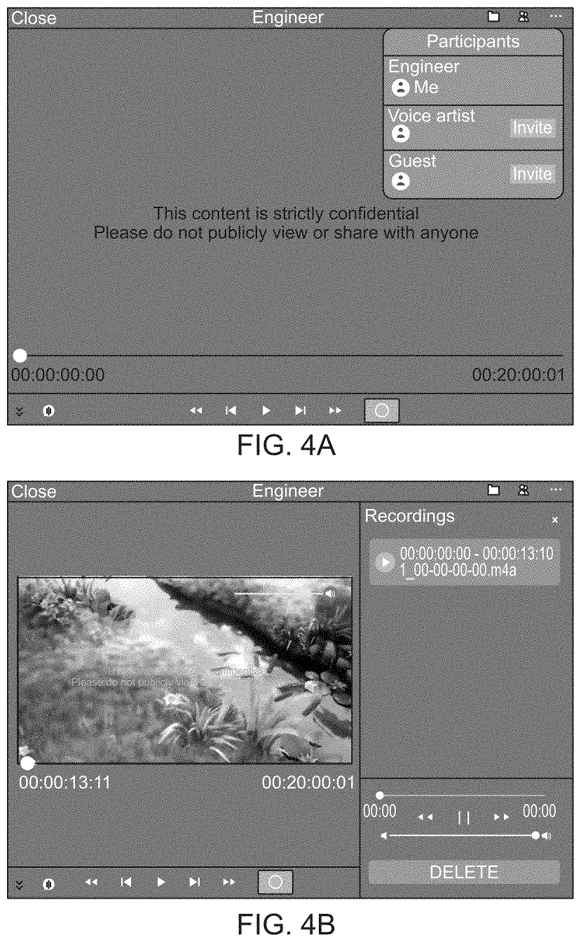

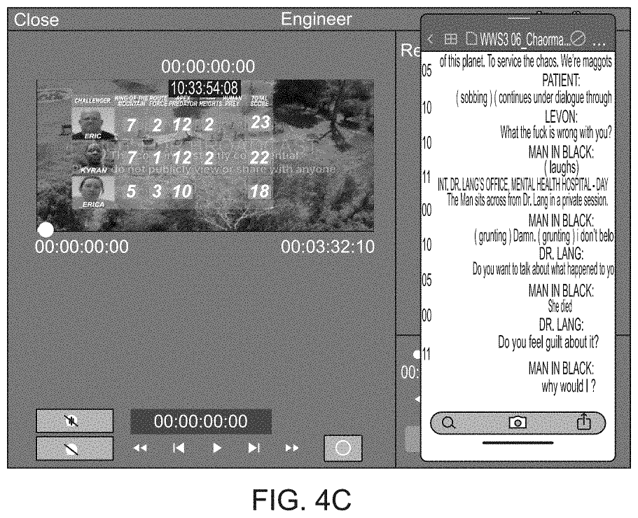

FIGS. 4A to 4C show various screenshots from this App as follows. FIG. 4A is a screenshot of the sound engineer's screen prior to starting a recording session. FIG. 4B is a screenshot of the sound engineer's screen after a sound clip has been recorded. The voice talent dubber will see a similar screen during the recording process. FIG. 4 C is a screenshot of the sound engineer's screen after a recording has been made, showing the various participants involved, and the dialog that the voice talent dubber has been reading during the recording. In operation, the voice talent dubber's iPad simultaneously displays a video for dubbing and a script for dubbing on the same device screen. This is seen in FIG. 4C which shows an exemplary script for the voice dubber to read.

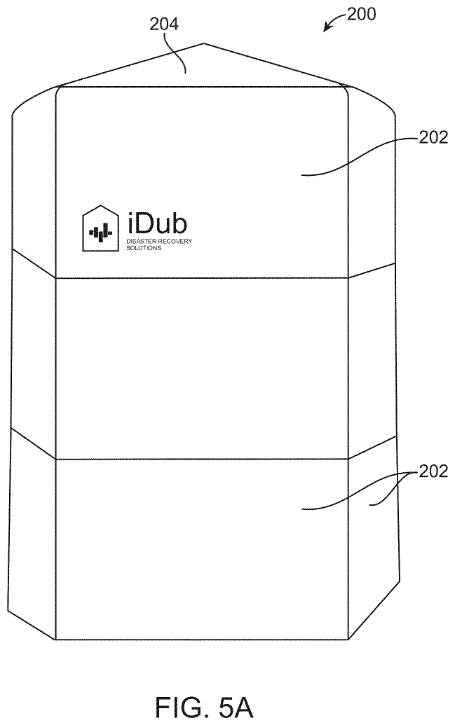

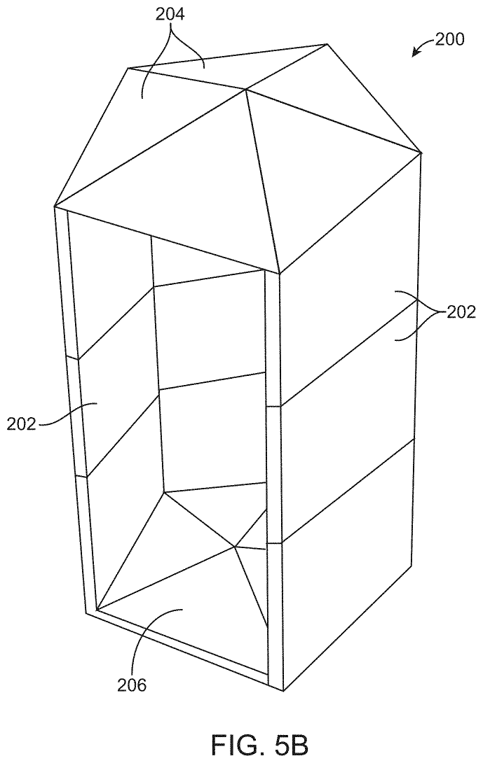

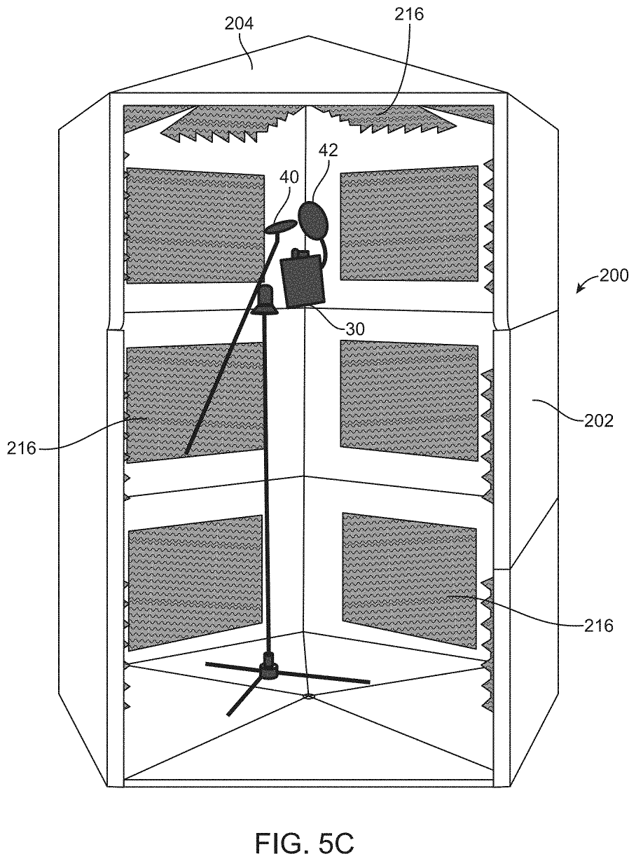

FIGS. 5A to 5C show views of an alternate (i.e.: pentagon shaped) embodiment of the present soundproof booth, as follows. Soundproof booth 200 is made from fifteen wall sections 202, five ceiling sections 204 and five floor sections 206 which are connected together to form the desired “pentagon-shaped” soundproof booth 200. FIG. 5C shows the stand for the microphone 40, pop filter 42 and iPad 30.

One advantage of the pentagon shaped soundproof booth of FIGS. 5A to 5C is that it has no parallel walls. This design therefore reduces the potential for sound reflection within the booth. The slight angling of the ceiling sections 204 (both to one another and to the floor sections 206), further reduces the potential for sound reflection. Similar to the embodiments of FIGS. 3A to 3H, the user preferably places a rug on the floor of booth 200 to further reduce sounds. In preferred aspects, sections 202, 204 and 206 are fastened together by zippers. It is to be understood, however, that the present invention is not so limited, and that other methods of attaching these sections together are also includes within the scope of the present invention. As best seen in FIG. 5C, acoustic insulation sections 216 are preferably attached to sections 202, 204 and 206. Acoustic insulation sections 216 can be composed of multiple pyramid-shaped projections to further reduce sounds within the booth. Sections 2020, 204 and 206 can comprise compressed polyester, which has sound absorbent properties. Also included in preferred aspects is a fresh air circulation system for providing a comfortable working environment for the voice dubbing professional.

What is claimed is:

1. A soundproof audio dubbing structure with integrated sound management system, comprising:
a soundproof booth, comprising:
a collapsible support structure, and
a plurality of soundproof material sections attached onto the collapsible support; and
an audio dubbing system for recording and managing audio files, comprising:
a video display system,
an audio recording system,
an audio and video file management system, and
a communication system for transmitting audio and video files over the internet.

2. The system of claim 1, wherein the plurality of soundproof material sections are configured to be attached onto the collapsible support structure after the support structure has been assembled into a deployed position.

3. The system of claim 1, wherein the collapsible support structure is formed from a plurality of panel sections that are connected together to form a pentagon shaped support structure.

4. The system of claim 1, wherein the audio dubbing system is positioned within the soundproof booth after the soundproof booth has been assembled into the deployed position.

5. The system of claim 1, wherein the plurality of soundproof material sections are made of an acoustic foam.

6. The system of claim 2, wherein the collapsible support structure comprises:
a support frame, and
a fabric disposed around the support frame.

7. The system of claim 6, wherein the plurality of soundproof material sections are secured to the fabric or support frame by hook and loop fasteners.

8. The system of claim 1, wherein the audio and video file management system watermarks recorded audio files with participant IDs.

9. The system of claim 1, wherein the audio and video file management system is resident in a software Application that is downloaded onto an iPad, computer or smart device.

10. The system of claim 1, the audio and video file management system and the communication system are configured for real-time communication between a plurality of users each operating within one of a plurality of the soundproof audio dubbing structures with integrated sound management system.

11. The system of claim 1, wherein the soundproof booth and the audio dubbing system are packaged and shipped separately to the user.

12. The system of claim 1, wherein the audio recording system comprises:
a microphone stand positioned in the deployed soundproof booth, and
an audio dubbing system stand positioned in the deployed soundproof booth.

13. The system of claim 1, wherein the video display system simultaneously displays a video for dubbing and a script for dubbing on the same device screen.

14. The system of claim 1, wherein the operation of the audio dubbing system for recording and managing audio files is controlled remotely.

15. A method of audio dubbing, comprising:
assembling a soundproof booth;
positioning an audio dubbing system for recording and managing audio files within the assembled soundproof booth,
displaying videos to a person in the soundproof booth,
recording audio clips from the person in the soundproof booth, and
transmitting the recorded audio clips to a remote computer system.

16. The method of claim 15, wherein assembling the soundproof booth comprises deploying a collapsible support structure into a deployed position, and attaching soundproofing material to the deployed support structure.

17. The method of claim 15, wherein assembling the soundproof booth comprises assembling a plurality of panel sections that are connected together to form a pentagon shaped support structure.

18. The method of claim 15, further comprising watermarking recorded audio files with participant IDs.

19. The method of claim 15, wherein the operation of the audio dubbing system for recording and managing audio files is controlled remotely.

20. The method of claim 15, further comprising real-time communication between a plurality of users each operating within one of a plurality of the soundproof booths.
